(19) United States
(12) Patent Application Publication
(10) Pub. No.: US 2018/0093613 A1
(43) Pub. Date: Apr. 5, 2018

(54) VEHICLE DRIVING ASSIST SYSTEM

(71) Applicant: FICO Mirrors, S.A.U., Barcelona (ES)

(72) Inventors: David Gómez Timoneda, Barcelona (ES); Frederic Lorival, Torfou (FR); Robert López Galera, Sant Boi de Llobregat (ES); Oriol Biosca Yuste, el Masnou (BCN) (ES)

(21) Appl. No.: 15/725,088

(22) Filed: Oct. 4, 2017

(30) Foreign Application Priority Data
Oct. 4, 2016 (EP) 16382455.0

(51) Int. Cl. B60R 1/12; B60R 1/00; H04N 7/18

(52) U.S. Cl. CPC B60R 1/12; B60R 1/00; H04N 7/181; B60R 2300/8066; B60R 2300/105; B60R 2300/806; B60R 2300/308; B60R 2001/1253

(57) ABSTRACT

A vehicle driving assist system includes at least a first camera (1) located at a rear part of the vehicle (10) for capturing a first field of view (11) outside of the rear of the vehicle (10). The first field of view (11) is larger than a second field of view (12) covered by a transflective element (22) of an optional rear-view mirror (21). The system further includes: a display (2) configurable for displaying an image of the first rear field of view (11) captured by the at least one, first camera (1); processing means for modifying the image to be displayed by the display (2) and for overlaying on the image displayed by the display (2) at least a reference line (41, 51, 52, 52′) which corresponds to a predetermined distance at ground level (40) from the driver's ocular points (42) or from the rear of the vehicle (10).

### BACKGROUND

The present invention has its application within the assistance devices for driving vehicles (cars, motorcycles, trucks, buses, etc.).

The present invention generally relates to design and construction of a driving assist system comprising cameras and display for use in vehicles to assist the driver in any steering operation, forward and reverse maneuvers.

Different drive support systems exist providing the vehicle driver with an image of a side rear/centered rear area of the vehicle captured by a camera. Image displayed from the cameras lacks depth because disappear the driver's vehicle reference, resulting in safety risk for the driver as it is not apparent how far from the vehicle's rear are the rear vehicles in forward driving or rear objects/vehicles in reverse driving. Traditional rear-view mirrors provide a reference for the driver as the image reflects also the rear window frame or the rear part of the vehicle (for side rear-view mirrors).

These rear vision devices enhance the rear field of view but the reference for the driver is lost. When driving forward, this lost reference causes the driver to hesitate whether the rear vehicle is far enough to perform the desired maneuver, such as a lane change. When reverse driving, this lost reference causes the driver to hesitate whether the approaching rear objects (static or dynamic) are close enough to collide against the vehicle. This situation is especially relevant when maneuvering for parking.

An example of parking assist device is disclosed in JP 2004-142741. This parking assist device draws guide lines of a vehicle width in a moving direction (a backward direction) of a vehicle and displays a ladder-shaped diagram, in a superimposed manner, in which the guide lines are connected at intervals of a predetermined distance. The device displays an anticipated traveling locus in a superimposed manner, for example, according to a steering angle detected by a steering sensor.

An example of supporting driving at the time of lane change is disclosed in JP 2006-51850, which describes a drive support apparatus that displays a guide line (a transverse line traversing a monitor), in a superimposed manner, at a boundary position of a dangerous area, a caution area, or a safety area on a road surface, decided based on distance or relative speed.

However, the existing drive support apparatuses have problems. In the device disclosed in JP 2004-142741, when it is applied to lane change during traveling, it is difficult to intuitively learn the distance from other vehicles by simply displaying the ladder-shaped diagram having a predetermined distance interval. For example, when a vehicle is present between a fifth compartment and a sixth compartment of the ladder shape display having an interval of 3 m, the driver needs to convert the distance, for example, 3 m (per vehicle)×4 (vehicles)=12 m. Further, since a distant vehicle that is at a predetermined distance or more from the rear end of the subject vehicle is hidden by the superimposed displayed diagram, it is difficult to recognize the presence of the vehicle. In the device disclosed in JP 2006-51850, in the side rear image captured at a wide angle, a lane passes in an oblique direction. Thus, it is difficult to understand a positional relationship between a vehicle and a guide line in the image through a guide line of a transverse straight line form, and it is difficult to intuitively learn the distance from other vehicles. Furthermore, this system solely works either with left/right turns or when the vehicle changes the road lane.

U.S. Pat. No. 7,940,193 discloses an apparatus to assist a parking operation of a vehicle which captures an image of a backward view of the vehicle and displays in the captured image a guiding portion to guide the vehicle into a target parking space. The display of the apparatus, inside the vehicle, superimposes on the captured image two assisting lines: a first assist line arranged in the target parking space to be in parallel to a front-rear direction of the target parking space and a second assist line extending to a backward area of the vehicle to be in parallel to a front-rear direction of the vehicle. The first and second assist lines are possibly overlapped each other when a vehicle reverse movement with the turning movement is completed. The first assist line is displayed so as to be static on the screen with respect to the target parking space and in accordance with the turning movement of the vehicle. The second assist line is displayed so as to be static on the screen during the turning movement of the vehicle. Both static lines could disturb the driver's vision and be more an annoyance than a commodity.

Therefore, it is highly desirable to provide a drive support system which allows the driver judge about the distance to other nearby vehicles or rear objects in a more intuitive, accurate and comfortable way in forward and rearward driving maneuvers.

### SUMMARY OF THE INVENTION

The present invention solves the aforementioned problems and overcomes previously explained state-of-art work limitations by providing at least one reference line superimposed on the displayed image from at least one camera of the vehicle drive assist system to provide the driver with a reference that can aid to interpret the relative position of the rear vehicles or rear (static or dynamic) objects. These reference lines are generally referred to as overlays and are set at a predetermined position which corresponds to a predetermined distance at ground level.

An aspect of the present invention refers to a system for driving assistance in vehicles which comprises:
at least one (first) camera capturing a first field of view outside of the rear part of the vehicle and including the ground level;
a display configurable for displaying an image of the first rear field of view captured by the, at least one, camera; and
processing means for modifying the image displayed by the display and overlaying on said image at least a reference line which corresponds to a predetermined distance at ground level.

The display may be located at any point of the vehicle visible to the driver, i.e., a location which the driver's ocular points can be focused on, such as, dashboard, lateral doors, windshield, internal rear-view mirror, door windows, etc.

In the case that the vehicle comprises a rear-view mirror, the display may be integrated within it, working as a mirror displaying the image from an external camera with a rear field of view, or being between a transflective element (either allows the reflection of a part of the light and/or allows the transmission of lights therethrough) and the rear cover. The transflective element, when works as a mirror, can cover a second field of view outside of the rear part of the vehicle, the second field of view being smaller than the aforementioned first field of view.

Another aspect of the present invention refers to a rear-view mirror of a vehicle for driving assistance which comprises:
at least a transflective element and a rear cover, the transflective element covering a second field of view outside of the rear part of the vehicle, and
a display integrated in the rear-view mirror between the rear cover and the transflective element, the display being configurable for displaying an image of a first rear field of view of the rear part of the vehicle including ground level and captured by at least a first camera located at the vehicle, wherein the image to be displayed by the display is modified by processing means configured to overlay on said image at least a reference line which corresponds to a predetermined distance at ground level from the vehicle.

The proposed rear-view mirror can be configured in two working modes. In a first working mode, the display is off, the transflective element receives more light from outside than inside the rear-view mirror, and the second field of view covered by the transflective element is shown in the rear-view mirror. In a second working mode, the display is on, the transflective element receives more light from the display, from inside than from outside the rear-view mirror, and the first field of view displayed by the display is viewable through the transflective element.

In the defined second working mode, the rear-view mirror can show an image, displayed by the display, of a third field of view outside of the rear part of the vehicle including ground level and nearer to the vehicle than the first field of view, which is captured by a parking camera located in the rear part of the vehicle. Also, the rear-view mirror can show an image, displayed by the display, of a fourth field of view of the rear part of the vehicle captured by a third camera located in the driver side part of the vehicle (and oriented toward a rear area of said vehicle. Furthermore, the rear-view mirror can show an image, displayed by the display, of a fifth field of view of the rear part of the vehicle captured by a fourth camera located in the opposite-driver side part of the vehicle and oriented toward a rear area of said vehicle.

The image displayed by the display and shown by the rear-view mirror working in the second working mode can be modified, according to the direction of the movement of the vehicle, by processing means. In a possible embodiment, the rear-view mirror shows the first field of view, in the case of forward direction of the vehicle; and if rearward direction: i) the rear-view mirror can show the third field of view, replacing the first field of view by the third field of view, or ii) it can show both the first and the third fields of view. In another possible embodiment, if the vehicle is moving in a forward direction, the rear-view mirror can show the images of the first camera in a middle area of the rear-view mirror and the image of the third and fourth cameras adjacent to the middle area; if rearward direction, the rear-view mirror can show: i) the images of the parking camera in the middle area of the rear-view mirror and the image of the third and fourth cameras adjacent to the image of the parking camera, or ii) the images of the parking camera and first camera in the middle area of the rear-view mirror, one adjacent to the other or one inside to the other, and the image of the third and fourth cameras adjacent to the middle area.

The present invention has a number of advantages with respect to prior art, which can be summarized as follows. The use of overlaid horizontal reference lines during forward/rearward driving can be used as references, advises and alarms for the driver to be aware of the relative position of the vehicle with respect to other vehicles and obstacles, and allows the definition of a security distance. Moreover, the use of overlaid vertical reference lines to delimitate a predetermined width, e.g., the vehicle width, the width of road lanes, etc., also improves references of the vehicle. Furthermore, the use of the aforementioned overlays can be displayed depend on any action of the driver/vehicle (left/right turn, change of the road lane, etc.) or not (the driver can manually switch the overlaid display on/off and change the display of the overlays; also, the overlays on the display can automatically appear or disappear according to the system configuration). The driver can modify the number and other parameters of the overlays (as colors, distances, length, patterns, etc.) to customize the aid level that the driver wants to be provided with by the assistance system. This customization is also possible by the facilities for withdrawing or modifying the overlays position (distance reference), manually or automatically according to different parameters such as vehicle's speed, forward/rearward gear position, or distance with the rear car, to name but a few. In addition, the assistance system provides the option to include an overlay which is variable automatically according with safety requirements and/or tips.

These and other advantages will be apparent in the light of the detailed description of the invention.

### DESCRIPTION OF THE DRAWINGS

For the purpose of aiding the understanding of the characteristics of the invention, according to a preferred practical embodiment thereof and in order to complement this description, the following Figures are attached as an integral part thereof, having an illustrative and non-limiting character:

FIG. 1 shows a schematic representation of a vehicle driving assist system for rear vision, according to a first embodiment of the invention.

FIG. 2 shows a schematic representation of a vehicle driving assist system for rear vision, according to a second embodiment of the invention.

FIG. 3 shows an exploded view of a rear-view mirror of the vehicle driving assist system, according to a possible embodiment of the invention.

FIG. 4 shows a schematic representation of the vehicle using horizontal reference lines overlaid on the display, according to a possible embodiment of the invention.

FIG. 5 shows a schematic representation of the vehicle using horizontal and vertical reference lines overlaid on the display, according to another possible embodiment of the invention.

### DETAILED DESCRIPTION OF THE INVENTION

The matters defined in this detailed description are example embodiments provided to assist in a comprehensive understanding of the invention. Accordingly, those of ordinary skill in the art will recognize that variation changes and modifications of the embodiments described herein can be made without departing from the scope and spirit of the invention. Also, description of well-known functions and elements are omitted for clarity and conciseness.

Of course, the embodiments of the invention can be implemented in a variety of architectural platforms, operating and server systems, devices, systems, or applications. Any particular architectural layout or implementation presented herein is provided for purposes of illustration and comprehension only and is not intended to limit aspects of the invention.

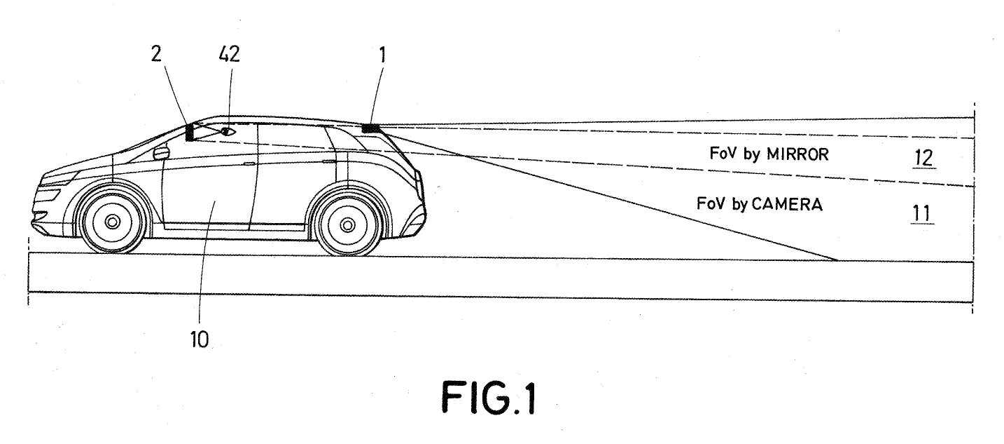

FIG. 1 presents a vehicle (10) with a driving assist system for rear vision, according to a first preferred embodiment of the invention, which comprises at least a first camera (1) located in a rear part of the vehicle (10) and oriented toward a rear area of said vehicle (10) such that it captures a first field of view (11) of the vehicle rear. A display (2), which can be located within an interior rear-view mirror (21), is configured to display a rear view field which depends on the working mode. The rear-view mirror (21) can be configured in two working modes.

In a first mode, “display off”, the rear-view mirror (21) is working as a mirror reflecting a second rear field of view (12) through a transflective element (22), i.e., a mirror which reflects and transmits part of the light, the transflection characteristics being fix or variable and adjustable through voltage. The transflective element (22) receives more light from the outside than the display (2) and therefore the image reflected is viewable by the driver through the transflective element (22).

In a second mode, “display on”, the rear-view mirror (21) is working as a display configured to display the first rear field of view (11) captured by the first camera (1) through the transflective element (22). When the display (2) is placed in the interior rear-view mirror (21), the rear image displayed by said display (2) replaces the rear image reflected by the transflective element (22) as it has substantially the same focal distance as the driver when looking at objects through the rear-view mirror (21) from the driver's ocular point (42). The transflective element (22) receives more light from the display (2) than the outside and therefore the driver sees the image displayed by the display (2) through said transflective element (22).

The image displayed by the display (2) covering the first rear field of view (11) is larger than the second rear field of view (12) image reflected by the transflective element (22) of the rear-view mirror (21).

In a variation of this embodiment, the display (2) may be out of the interior rear-view mirror (21) and displays the first rear field of view (11) captured by first camera (1) when the display (2) is “on”.

Another variation of this preferred first embodiment comprises at least a third camera located in the driver-side part of the vehicle (10) and oriented toward a rear area of said vehicle (10) such that it captures a fourth field of view of the vehicle rear, this camera may be integrated in the same driver-side rear-view mirror or replace said driver-side rear-view mirror. A display (2), which can be located within either an interior rear-view mirror (21), or dashboard, driver lateral door, windshield, driver-door window, etc., is configured to display that fourth field of view.

An improvement of this variation is that the embodiment also comprises a fourth camera located in the opposite-driver side part of the vehicle (10) and oriented toward a rear area of said vehicle (10) such that it captures a fifth field of view of the vehicle rear, this camera may be integrated in the same opposite-driver side rear-view mirror or replace said opposite-driver side rear-view mirror. A display (2), which can be located within either an interior rear-view mirror (21), or dashboard, opposite-driver lateral door, windshield, opposite-driver door window, etc., is configured to display that fifth field of view.

In addition, the driving assist system further comprises a controller with image processor which modifies the image received by the camera (1), adding when it is necessary reference overlays, and modifies the image to be displayed by the display (2). The controller may have data input means, e.g., a user interface, to allow the user change parameters of the overlays. Also, the user may input data by means of the steering wheel levers to modify manually the overlays. The controller may be located at the same location of the display (2), inside or outside the interior rear-view mirror (21) and even could be a controller located in other places and used for controlling other parameters too.

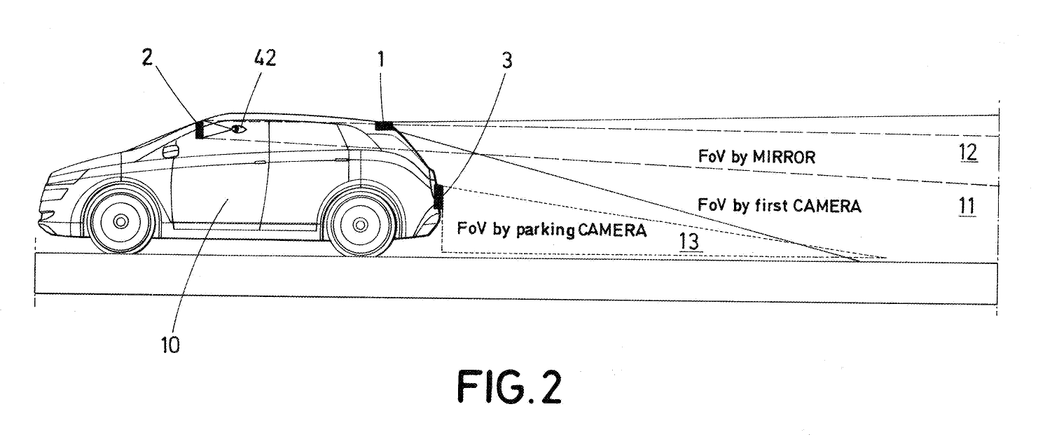

FIG. 2 shows a second embodiment of a driving assist system for rear vision in a vehicle (10) which comprises at least a first camera (1) located in a rear part of the vehicle (10) and oriented toward a rear area of said vehicle (10) such that it captures a first field of view (11) of the vehicle rear. At least a parking camera (3) is located in a rear part of the vehicle (10) and oriented toward the rear area of said vehicle (10) such that it captures a third field of view (13) of the vehicle rear next to the vehicle (10). A rear-view mirror (21), integrating a display (2), has two different working modes: a first mode, the rear-view mirror (21) working as a mirror, reflecting a rear second field of view (12) through a transflective element (22); and a second mode, the rear-view mirror (21) working as a display, configured to display the rear field of view captured by the first camera (1) through the transflective element (22). This rear image is displayed by the display (2) integrated in the rear-view mirror (21) and replaces the rear image reflected by the transflective element (22) of said rear-view mirror (21).

In this second embodiment, when the rear-view mirror (21) works displaying the images captured by the cameras (1, 3), the display (2) displays the image from the first camera (1) or the parking camera (3) depending on at least two different parameters: gear shift position and direction of movement. An example of the gear shift position parameter is if the gear shift position is in reverse shift position, the display (2) displays the image captured by the parking camera (3); and if the gear shift position is out of the reverse shift position, the display (2) displays the image captured by the first camera (1). An example of the direction of movement parameter is if the vehicle (10) is in rearward movement, the display (2) displays the image captured by the parking camera (3), and if the vehicle (10) is not in rearward movement, the display (2) displays the image captured by the first camera (1).

Finally, another option of displaying is that the display (2) always displays the image of the first camera (1) and when the system detects that images from the parking camera (3) have to be displayed, the display (2) displays both images, one adjacent to the other or one inside the other.

A variation of this second embodiment is adding one or both side cameras to the system. Then the display could work in one of the following ways. During forward driving, the display (2) shows the images of the first camera (1) in the middle and the image of every side camera adjacent to the middle image, or the display (2) only shows the images of the first camera (1), and in a change of road lane or activating a turn signal the display shows the image of the first camera (1) and adjacent the image of the side camera where the vehicle (10) moves. During backward driving, the display (2) shows the images of the parking camera (3) in the middle and the image of every side camera adjacent to the parking camera image, or the display (2) shows the images of the parking camera (3) and first camera in the middle, one adjacent to the other or one inside to the other, and the image of every side camera adjacent to the middle image.

In this second embodiment, the system further comprises a controller with image processor to modify the image received by the cameras (1, 3), adding when it is necessary the overlays on the images from both the cameras (1, 3), and in order to modify the image to be displayed by the display (2) according to the direction of the movement: if forward, the image from the first camera (1) is displayed; if rearward, the image from the parking camera (3) is displayed. This controller may also have means for inputting data, in the display (2), steering wheel levers, etc., by a user to modify parameters of the overlays: color, patterns, length in which the overlaid reference line is displayed and/or the predetermined distance to which said reference line corresponds. The controller may be located at the same location of the display (2), inside or outside the rear-view mirror (21) and even could be a controller located in other places and used for controlling other parameters too.

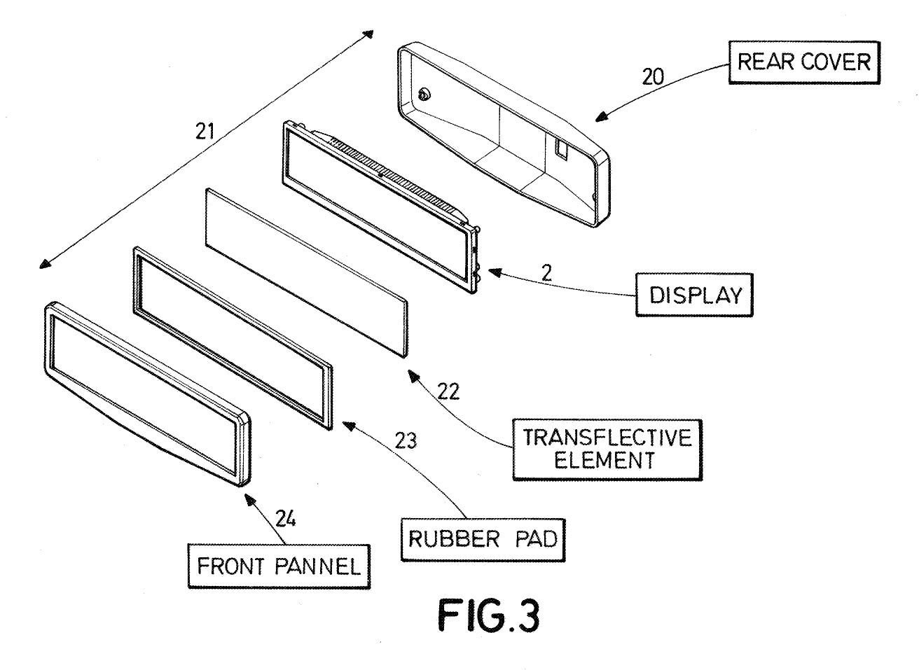

As shown in FIG. 3, the display (2), e.g., a LED display, can be located behind a transflective element (22). FIG. 3 shows the display (2) located in a rear-view mirror (21) which comprises a housing having a rear cover (20) and a front panel or frame (24). A display (2) and a transflective element (22) either allows the reflection of a part of the light and/or allows the transmission of lights therethrough. This transflective element (22), generally known as a half mirror or a one-way mirror, is shown mounted on the display (2) in front of the display (2) and fit together between the rear cover (20) and front frame (24) by means of a rubber pad (23). The transflective element (22) may be either a passive half mirror, with fixed characteristics of transmittance ant reflectance, or an active mirror that may modify through an electric voltage its characteristics of transmittance or/and reflectance. For example, the transflective element (22) may be an ordinary mirror, coated on its back surface with a thin layer of metal, usually silver or aluminum, such that reflects some light and is penetrated by the rest. Also, different types of mirror elements may be used, with electro-optic elements having variable transmittance and/or reflectance adjustable through variable voltage. Also, the display (2) may be installed directly in the vehicle (10) out of the rear-view mirror (21), such as dashboard, lateral doors, windshield, internal rear-view mirror, lateral-door windows, etc.

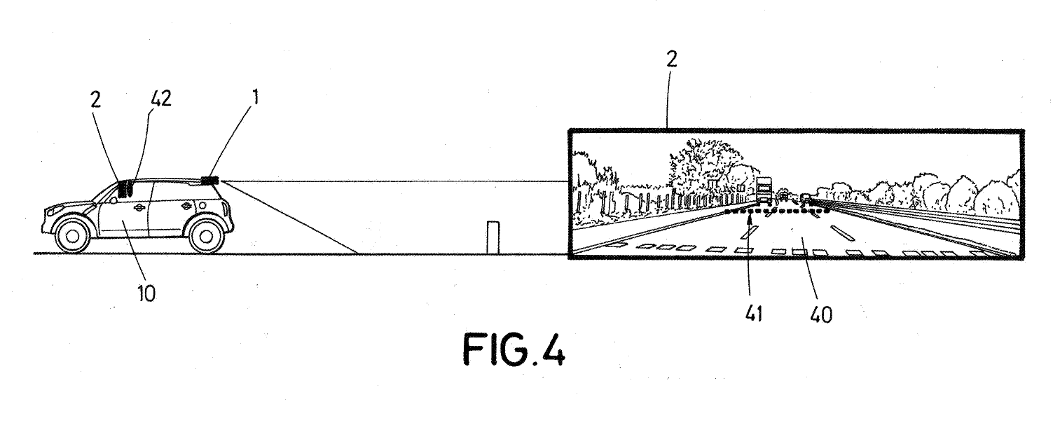

FIG. 4 shows a possible embodiment of the invention which comes to solve the loss of references when driving forward, for example when the driver maneuvers to change the lane. At the top of the image displayed by the display (2) a first horizontal reference line (41), for example displayed in a first colour, e.g., blue, is represented to provide the driver a reference that can aid to interpret the relative position of the rear vehicles. This first horizontal reference line (41) is set at a predetermined position which corresponds to a first predetermined distance at ground level (40), e.g., 50 m, from the driver's ocular point (42) or from the rear part of the vehicle (10). This distance and its measurement are configurable.

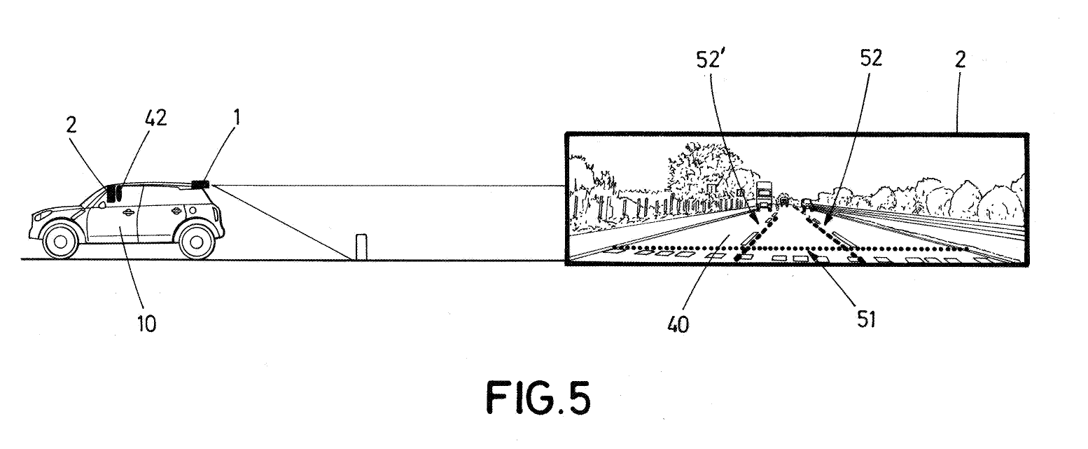

FIG. 5 shows an improvement of the above-described embodiment presented in FIG. 4. At the top of the image displayed by the display (2) a second horizontal reference line (51) is represented to provide the driver with a reference that can aid to interpret the relative position of the approaching rear objects.

Additionally, to aid for driving forward, the display (2) also overlays two vertical oblique lines (52, 52′), e.g., displayed in other colour different from the colour of the horizontal line (51), to provide the driver with a reference of the vehicle's width or even the road/road lane width to aid to interpret the lateral relative position of the approaching rear vehicles.

Since the use of these reference lines (41, 51, 52, 52′) could become more an annoyance than a commodity inside of the city, where the speed of the vehicles is limited, or in a traffic jam of a highway, when the driving speed is also low and we can have a rear or next vehicle very close, closer that the beginning of the first field of view (11), an indicative of the need of any of these reference lines (41, 51, 52, 52′) can be configured and based on a range of speed and/or the distance between the vehicle and the rear vehicle. Therefore, in a possible embodiment of the invention, the system further comprises processing means, e.g., a controller, for activating and deactivating the reference lines (41, 51, 52, 52′) by the display (2) depending on a threshold of driving speed and/or the distance between the vehicle and the rear vehicle, which is probed by a sensor provided in the vehicle (10). For example, when driving at high speed, the predetermined distance at ground level (40) of the first horizontal reference line (41), and of the second horizontal reference line (51) if the latter is also used, should be modified to set a larger predetermined distance for security. Optionally, the driver can change manually some other characteristics of the reference lines (41, 51, 52, 52′), such as adding lines, modifying the color, patterns, length in which the line is displayed, in addition to changing the predetermined distance to which said reference line corresponds as described before. For this purpose, the system further comprises data input means in the steering wheel levers, on the display, on the housing of the display or the rear-view mirror, etc., to allow the driver modify the characteristics of the overlays of the images from any of the cameras (1, 3).

Note that in this text, the term “comprises” and its derivations (such as “comprising”, etc.) should not be understood in an excluding sense, that is, these terms should not be interpreted as excluding the possibility that what is described and defined may include further elements, steps, etc.

What is claimed is:

1. A system for assisting a driver in driving a vehicle, comprising:
at least a first camera for capturing a first field of view outside of the rear part of the vehicle and including ground level, the system further comprising:
a display configurable for displaying an image of the first rear field of view captured by the, at least one, first camera;
processing means for modifying the image to be displayed by the display and for overlaying on the image displayed by the display at least a reference line which corresponds to a predetermined distance at ground level from the vehicle.

2. The system according to any preceding claim, further comprising at least a parking camera located in the rear part of the vehicle for capturing a third field of view outside of the rear part of the vehicle including ground level and nearer to the vehicle than the first field of view.

3. The system according to claim 2, wherein the processing means modify the image to be displayed by the display according to a direction of the movement:
if forward direction, the first field of view is displayed;
if rearward direction, the third field of view is displayed, the display replacing the first field of view by the third field of view or displaying both the first field of view and the third field of view.

4. The system according to claim 1, further comprising a third camera located in the driver side part of the vehicle and oriented toward a rear area of said vehicle for capturing a fourth field of view of the rear part of the vehicle and wherein the display is configured to display the fourth field of view.

5. The system according to claim 4, wherein the third camera is integrated in a driver side rear-view mirror of the vehicle.

6. The system according to claim 4, further comprising at least a fourth camera located in the opposite-driver side part of the vehicle and oriented toward a rear area of said vehicle for capturing a fifth field of view of the rear part of the vehicle and wherein the display is configured to display the fifth field of view.

7. The system according to claim 6, wherein the fourth camera is integrated in an opposite-driver side rear-view mirror of the vehicle.

8. The system of claim 1, further comprising a camera located in the opposite-driver side part of the vehicle and oriented toward a rear area of said vehicle for capturing a field of view of the rear part of the vehicle and wherein the display is configured to display the field of view of the rear part of the vehicle.

9. The system according to claim 6, wherein:
during forward driving of the vehicle, the display shows the images of the first camera in a middle area and the image of the
third and fourth cameras adjacent to the middle area, or the display only shows the images of the first camera, and in a change of road lane or activating a turn signal the display shows the image of the first camera and adjacently the image of the side camera where the vehicle moves,
during backward driving of the vehicle, the display shows the images of the parking camera in the middle area and the image of the third and fourth cameras adjacent to the image of the parking camera, or the display shows the images of the parking camera and first camera in the middle area, one adjacent to the other or one inside to the other, and the image of the third and fourth cameras adjacent to the middle image.

10. The system according to claim 1, wherein the processing means are configured to overlay on the image displayed by the display at least a first horizontal reference line corresponding to a first predetermined distance when driving forward and a second horizontal reference line corresponding to a second predetermined distance when driving backward.

11. The system according to claim 1, wherein the processing means are configured to overlay on the image displayed by the display at least two vertical oblique lines and the distance between the two vertical oblique lines corresponding to a predetermined width.

12. The system according to claim 1, wherein the overlay of the, at least one, reference line displayed by the display is activated, modified, or deactivated automatically based on the speed of the vehicle or the distance with a rear object.

13. The system according claim 1, wherein the display displays the, at least one, reference line according to a parameter which is configurable by the driver, the parameter being selected from color of the line, pattern of the line, length in which the line is displayed in the display and the predetermined distance to which the reference line corresponds.

14. The system according to claim 13, further comprising data input means for the driver to modify the parameter of at least one reference line, the data input means being located in steering wheel levers of the vehicle, on the display, or on a rear-view mirror.

15. The system according to claim 1, further comprising a rear-view mirror comprising at least a transflective element and a rear cover, the transflective element covers a second field of view outside of the rear part of the vehicle, the second field of view being smaller than the first field of view, and wherein the display is integrated in the rear-view mirror between the rear cover and the transflective element.

16. The system according to claim 1, wherein the display is at a location in the vehicle selected from dashboard, driver lateral door, opposite-driver lateral door, windshield, driver-door window and opposite-driver lateral window.
